(19) United States
(12) Patent Application Publication
(10) Pub. No.: US 2010/0037805 A1
(43) Pub. Date: Feb. 18, 2010

(54) Method of and Apparatus for Controlling the Temperature of a Fluidized Bed Reactor

(75) Inventor: Markku Itapelto, Varkaus (FI)

Correspondence Address: FITZPATRICK CELLA HARPER & SCINTO, 1290 Avenue of the Americas, NEW YORK, NY, 10104-3800, US

(73) Assignee: FOSTER WHEELER ENERGIA OY, Espoo (FI)

(21) Appl. No.: 12/518,669

(22) PCT Filed: Dec. 11, 2007
(86) PCT No.: PCT/FI07/50673

§ 371 Date: Oct. 22, 2009

(30) Foreign Application Priority Data
Dec. 11, 2006 (FI) 20065790

(51) Int. Cl. F23N 5/00; G05B 1/00; B01J 8/18

(52) U.S. Cl. 110/186; 422/141; 422/142; 422/105

(57) ABSTRACT

A method of and an apparatus for controlling the temperature of a fluidized bed reactor, comprising a separator for separating first solid particles from the fluidized bed reactor, a return duct for returning a first portion of the first solid particles to the fluidized bed reactor, a discharge duct for the discharge of a second portion of the first solid particles and an inlet duct for transferring second solid particles from a second fluidized bed reactor to the fluidized bed reactor, in which the return duct and the inlet duct share a common end portion for transferring a mixture of solid particles, formed of the first portion of the first solid particles and the second solid particles, to the fluidized bed reactor. The apparatus also preferably includes a fluidized mixing device for mixing the first portion of the solid particles and the second solid particles with each other.

This application is a U.S. national stage application of PCT International Application No. PCT/FI2007/050673, filed Dec. 11, 2007, published as PCT Publication No. WO 2008/071842 A1, on Jun. 19, 2008, and which claims priority from Finnish patent application number FI-20065790, filed Dec. 11, 2006.

### FIELD OF THE INVENTION

The present invention relates to a method of and an apparatus for controlling the temperature of a fluidized bed reactor arranged in connection with a second fluidized bed reactor.

Thus, the invention especially relates to an apparatus comprising a separator for separating first solid particles from the fluidized bed reactor, a return duct for returning a first portion of the first solid particles to the fluidized bed reactor, a discharge duct for removing a second portion of the first solid particles, and an inlet duct for transferring second solid particles from a second fluidized bed reactor to the fluidized bed reactor. Further, the invention especially relates to a method, in which first solid particles are separated from a second fluidized bed reactor to the fluidized bed reactor. Further, the invention especially relates to a method, in which first solid particles are separated from the fluidized bed reactor, a first portion of first solid particles is transferred along a return duct back to the fluidized bed reactor, a second portion of the first solid particles is removed, and second solid particles are transferred along an inlet duct from a second fluidized bed reactor to the fluidized bed reactor.

The reactions occurring in the fluidized bed reactors, such as combustion reactions, are often exothermic. Thus, the energy released in the reactions can usually be bound to steam or another heat transfer medium in such a way that it is possible to bring about a temperature which is advantageous, for example, in view of minimizing the emissions. When the reactions taking place in a fluidized bed reactor are endothermic, such as pyrolytic reactions, outside energy must be introduced to the reactor. When an endothermic fluidized bed reactor is in connection with another fluidized bed reactor, which is exothermic, one known method of bringing energy to the endothermic fluidized bed reactor is to transfer hot bed material there from the exothermic fluidized bed reactor. Correspondingly, it is possible to adjust the temperature of the other types of fluidized bed reactors, which are also exothermic fluidized bed reactors, to a desired value, by exchanging bed material between the fluidized bed reactor and a second fluidized bed reactor having a different temperature, for example, a lower temperature.

Preferably, the fluidized bed reactor to which the temperature control in accordance with the invention relates, the so-called first fluidized bed reactor, is a circulating bed pyrolyzer, and the second fluidized bed reactor in connection with the pyrolyzer is a fluidized bed combustion plant, for example, a large circulating fluidized bed boiler. It is, thereby, an object of the temperature control to maintain a temperature in the circulating fluidized bed pyrolyzer which is desired and advantageous for the pyrolysis process, by utilizing bed material heated in the large circulating fluidized bed boiler.

U.S. Pat. No. 3,853,498, No. 4,344,373, No. 4,364,796, and No. 5,946,900 each discloses arrangements, in which the temperature required by the pyrolysis process is maintained in the fluidized bed pyrolyzer by introducing there hot bed material from a separate fluidized bed combustion plant. At the same time, char generated in the process and having a lower temperature is removed from the pyrolyzer to be combusted in the combustion plant. In the plants disclosed in these patents, it is possible to adjust the temperature of the pyrolyzer by changing the mass flow of the hot bed material transferred from the combustion plant to the pyrolyzer.

In a so-called quick pyrolysis, organic material is heated in non-oxygenous conditions quickly to a temperature of about 450 to about 600° C. Thereby, vaporized organic compounds, pyrolysis gases and char, are generated in the process. At a later stage in the process, pyrolytic oil of the vaporized organic compounds is condensed. The yield thereof (mass) is typically about 70 to about 75% of dry fuel. The yield of the pyrolytic oil depends on the temperature, the optimum temperature being typically approximately 500° C. If the temperatures are too low, the amount of the char increases and, correspondingly, if the temperatures are too high, an increasing portion of the pyrolytic gases are such that they do not condense to pyrolytic oils.

In order to maximize the yield of the pyrolysis process, it is important that the temperature distribution in the pyrolyzer be as even as possible. Especially, in a quick pyrolysis, in which the retention time of the fuel in the reactor is short, typically, less than one second, it is important to get the fuel quickly and accurately to an appropriate temperature. The fluidization of the bed material in a fluidized bed pyrolyzer generates as such a relatively homogeneous and stable process temperature, but in some cases, it has been noticed that part of the fuel in the fluidized bed pyrolyzer does not react at an appropriate pyrolysis temperature, which causes undesired chemical reactions and, for example, a decrease in the oil yield. Thus, there is a need to obtain an improved method and apparatus for controlling the temperature of the fluidized bed reactor efficiently, in such a way that as large a portion as possible of the fuel achieves the appropriate temperature, quickly and accurately.

### SUMMARY OF THE INVENTION

It is an object of the invention to provide an efficient method of and apparatus for controlling the temperature of a fluidized bed reactor, in which the above-described problems are minimized.

It is especially an object of the invention to provide an efficient method and apparatus, by means of which the temperature of a fluidized bed reactor in the proximity of a second fluidized bed reactor can be adjusted accurately and quickly.

In order to solve the above-mentioned prior art problems, an apparatus is disclosed. A characterizing feature of the apparatus is that the return duct and the inlet duct share a common end portion for transferring a mixture of solid particles formed of the first portion of the first solid particles and the second solid particles to the fluidized bed reactor.

In order to solve the above-mentioned prior art problems, a method is also provided. A characterizing feature of the method is that the first portion of the first solid particles and the second solid particles are mixed with each other, and the mixture of the solid particles thus formed is transferred along a common end portion of the return duct and the inlet duct to the fluidized bed reactor.

According to a preferred embodiment of the present invention, the fluidized bed reactor to which the temperature control relates, a so-called first fluidized bed reactor, is a fluidized pyrolyzer, in which organic substances are intended to chemically decompose without oxygen at a relatively high temperature, for example, at 500° C. The pyrolyzer is preferably a circulating fluidized bed pyrolyzer, the bed material of which is fluidized at a relatively high fluidization speed, whereby the gases rising in the reaction chamber entrain solid particles to a product gas duct. Thereby, solid particles, so-called first solid particles, are separated from the gas exiting the reactor by means of a particle separator, usually, a cyclone, arranged in the product gas duct. Especially, when the first fluidized bed reactor is of some other type than a circulating fluidized bed reactor, the separation of the first solid particles may preferably take place also by some other way than by a particle separator arranged in the product gas duct, for example, by a discharge duct for solid particles connected to the lower part of the reactor.

It is advantageous, in view of the speed of the temperature control, that the heat transfer between the heat carrying solid material and the material already in the bed or, especially, in the material being brought there, such as fuel, is as efficient as possible. Therefore, it is advantageous that the mass flow of the heat carrying solid material be as high as possible. According to the present invention, the temperature difference between the heat carrying solid material and the first fluidized bed reactor is diminished by mixing the stream of solid material coming from the second fluidized bed reactor, e.g., a boiler, which is in a temperature clearly deviating from that of the first fluidized bed reactor, by solid material, which is separated from the first reactor, for example, from the cyclone of a pyrolyzer, and which is substantially at the temperature of the reaction chamber of the first fluidized bed reactor. Thereby, the effective additional thermal energy transferred by the particles brought to the first fluidized bed reactor is substantially unchanged, but the mass flow of the particles brought for adjusting the temperature is larger, and their temperature deviates less from the temperature of the first reactor than without the addition of the particles separated from the first reactor.

Although the temperature distribution is, in the fluidized bed reactor, generally speaking, relatively even, it has been noted that an area may be formed close to the point where the material brought for adjusting the temperature is introduced, in which the temperature deviates from the temperature of the rest of the reaction chamber. When the temperature of the material used for adjusting the temperature does not deviate much from the temperature of the material already in the reaction chamber when using the temperature control method in accordance with the invention, an even more homogeneous temperature distribution is achieved in the reaction chamber. For example, the number of undesired chemical reactions caused by the non-homogeneous temperature distribution of the pyrolyzer is thereby diminished.

As it has already been stated, the first fluidized bed reactor may also be some other reactor than a pyrolyzer, for example, an exothermic reactor. The second fluidized bed reactor may be any other appropriate reactor, the temperature of which deviates in a desired manner from the temperature of the first fluidized bed reactor. When the method in accordance with the invention is used for increasing the temperature of the first fluidized bed reactor, the temperature of the second fluidized bed reactor must be higher than the temperature of the first fluidized bed reactor. When, in turn, the method is used for decreasing the temperature, the temperature of the second fluidized bed reactor must be lower than the temperature of the first fluidized bed reactor.

According to the present invention, the first portion of the first solid particles is returned along the return duct to the first fluidized bed reactor, preferably, a reaction chamber of the pyrolyzer, and the second portion is discharged, preferably, to a second fluidized bed reactor. In some cases, the second portion can also be discharged somewhere else, for example, to end storage or another application. According to a preferred embodiment of the invention, the second fluidized bed reactor is a relatively large fluidized bed boiler, having a furnace temperature of, for example, 850° C. The fluidized bed boiler is, preferably, a circulating fluidized bed boiler, but it can also be of some other type, for example, a bubbling bed boiler. When hot bed material of the fluidized bed boiler is introduced to a pyrolyzer at a considerably lower temperature, the pyrolyzer receives thermal energy required for the pyrolysis process.

In this connection, the focus is not particularly in the effect caused to the second fluidized bed reactor by the feeding of solid particles from the first fluidized bed reactor therein, but it is assumed, as if the second fluidized bed reactor would operate regardless of the feeding of solid particles. The exchange of bed materials of different temperatures affects, in reality, the heat balances of both reactors, and the solid material removed from the pyrolyzer can contain a lot of char, which can advantageously act as fuel of the second fluidized bed reactor.

The volume of the mass flow of the first portion of the first solid particles separated from the first fluidized bed reactor affects the temperature of the stream of particles fed to the first fluidized bed reactor, containing solid particles fed from the second fluidized bed reactor. For example, if the temperature of the solid particles separated from the first fluidized bed reactor is 500° C. and the temperature of the particles fed from the second fluidized bed reactor is 850° C., it is possible to adjust the temperature of the mixture flow fed to the first fluidized bed reactor to a desired value between 500° C. and 850° C., for example, to 650° C., by using a suitable mass flow of the first portion of the first solid particles. If it is assumed that the temperatures of the particle flows remain the same while being treated, the temperature of 650° C. is achieved, for example, in such a way that solid particles, which are at the temperature of 500° C., are separated from the first reactor in the amount of 35 kg/s, of which 15 kg/s are separated to the second reactor and 20 kg/s are returned to the first reactor, the latter mass flow being mixed together with the 15 kg/s mass flow of the particles having the temperature of 850° C., which are fed from the second reactor.

In order to control the temperature of the particle flow fed to the first fluidized bed reactor, it is advantageous that the return duct of the first portion of the first solid particles comprises a controller or control means, so-called first control means, to adjust the mass flow of the first portion of the first solid particles. If the total amount of the solid particle flow separated from the first fluidized bed reactor, preferably, by a cyclone from the product gas flow thereof, is even, and the whole particle flow is either discharged or it is returned to the first fluidized bed reactor, it is possible to control the temperature of the particle flow alternatively by control means of mass flow arranged in the discharge duct of the second portion of the first solid particles. A third alternative is to arrange the control means of the mass flow both to the return duct of the first portion of the first solid particles and to the discharge duct of the second portion of the first solid particles.

A conventional gas seal can also preferably be arranged to the return duct of the first portion of the first solid particles and to the discharge duct of the second portion of the first solid particles, the gas seal comprising a down leg and a fluidized lifting channel. Generally, a gas seal is used for preventing gas flow between spaces which are at different pressures. The gas seals in an arrangement in accordance with the present invention can act at the same time as control means for the distribution of the mass flow, for example, in such a way that the ratio between the amounts of mass flow removed and the mass flow returned to the first fluidized bed reactor are adjusted by means of the fluidization velocities of the lifting channels. The gas seals in the return duct of the first portion of the first solid particles and in the discharge duct of the second portion of the first solid particles can be either completely separate structures or they can have a common down leg.

Since the amount of the mass flow of the second solid particles fed from the second fluidized bed reactor also affects the temperature of the mass flow transferred to the first fluidized bed reactor, it is advantageous for the control of the temperature of the first fluidized bed reactor that the inlet duct of the second solid particles also comprises a controller or control means, so-called third control means, to adjust the mass flow of the second solid particles. The inlet duct, therefore, preferably comprises a gas seal structure, which has a fluidized lifting channel including fluidization control means. According to a preferred embodiment of the invention, the first portion of the first solid particles is guided to the upper part of the lifting channel of the inlet duct for the second solid particles, whereby the first portion of the first solid particles and the second solid particles efficiently mix with each other.

The controller or control means of the mass flow arranged in the return duct, the discharge duct and the inlet duct may also be of some other known type. These controllers or control means, or a part of them, can comprise, for example, an adjustable conveyor screw for the particulate mass.

The common end portion of the return duct and the inlet duct preferably comprise a temperature sensor of a conventional type for mixed solid particles, for example, a PT resistance thermometer or a thermocouple. Naturally, there is usually also at least one temperature sensor in connection with the reaction chamber of the first fluidized bed reactor, for example, for monitoring the temperature of the upper portion of the reaction chamber. The temperature control system in accordance with the present invention preferably comprises a conventional control system for guiding solid particle flows based on the measured temperatures.

The temperature of the reaction chamber is preferably controlled by guiding the third control means located in the inlet duct feeding solid particles from the second fluidized bed reactor based on the temperature measured in the upper portion of the first fluidized bed reactor. Further, according to an especially preferred embodiment of the present invention, the first control means controlling the amount of the mass flow of the first portion of the first solid particles is controlled based on the temperature of the mixed solid particles measured in the common end portion of the return duct and the inlet duct.

### BRIEF DESCRIPTION OF THE DRAWING

The invention is described in more detail with reference to the accompanying drawing, in which

FIG. 1 schematically illustrates a vertical cross section of the fluidized bed reactor in connection with a second fluidized bed reactor, the fluidized bed reactor having a temperature control system in accordance with a preferred embodiment of the present invention.

### DETAILED DESCRIPTION OF THE PREFERRED EMBODIMENTS

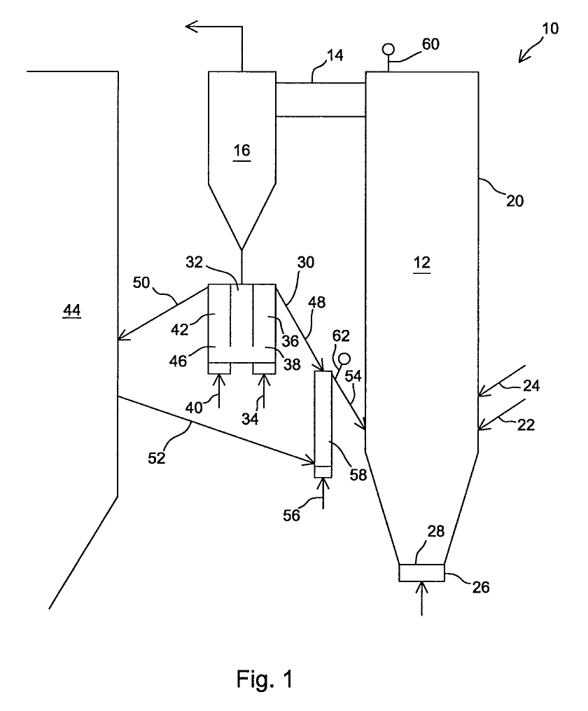

FIG. 1 illustrates a circulating fluidized bed pyrolyzer 10 in accordance with a preferred embodiment of the present invention, comprising a reaction chamber 12, a gas discharge duct 14 connected to the upper portion of the reaction chamber, and a particle separator 16 connected to the duct 14. Solid particles, especially, char particles, are separated from the pyrolysis gases by the particle separator 16. The pyrolysis gases are led from the particle separator 16 through a filter to a gas cooler (not shown in FIG. 1), in which pyrolyzation oil is condensed from the pyrolyzation gases. The uncondensed gaseous products are guided from the gas cooler for other use, for example, to be combusted or to be used as fluidization gas of the pyrolyzer 10. Conventional conduits 22, 24 are connected to side walls 20 of the reaction chamber 12, for example, for introducing fuel and inert bed material. There is a wind box 26 for fluidization gas beneath the reaction chamber 12, from which fluidization gas, for example, steam or uncondensed pyrolysis gases, are introduced through a grid 28 to the reaction chamber 12.

A return duct 30 is connected to the lower portion of the particle separator 16 for returning a first portion of the separated solid particles to the lower portion of the reaction chamber 12. The first portion of the return duct 30, a down leg 32, forms a gas seal 28 together with a lifting channel 36, which is fluidized by fluidizing means 34. The gas seal 38 prevents gas from flowing through the return duct 30 from the reaction chamber 12 to the separator 16.

There is also a second lifting channel 42 fluidized by fluidizing means 40 in connection with the down leg 32, through which lifting channel 42 it is possible to remove a second portion of the solid particles separated by the separator 16 to a second circulating fluidized bed boiler 44 close to the pyrolyzer. At the same time, the down leg 32 and the lifting channel 42 form a second gas seal 46, which prevents gas from flowing from the circulating fluidized bed boiler 44 to the separator 16. By changing the sizes of the fluidizing gas flows introduced by fluidizing means 34 and 40, it is possible to control the way the flow of the solid particles separated by the separator 16 is divided into a first portion to be led through the return duct 30 to the reaction chamber 12 and a second portion to be led through a discharge duct 50 to the circulating fluidized bed boiler 44.

The gas seals 38 and 46 may be formed according to FIG. 1 as one integrated structure, so that they have a common down leg 32 or, alternatively, the gas seals can be completely separate. In the latter case, the duct connecting to the lower portion of the particle separator 16 is divided at some point, for example, immediately beneath the particle separator 16, into two separate down legs.

Thermal energy required for the pyrolysis reactions is introduced to the reaction chamber 12 of the pyrolyzer 10 by transferring hot solid particles from the circulating fluidized bed boiler 44 along the inlet duct 52. According to the present invention, the extension portion 48 of the return duct 30 is connected to the inlet duct 52 in such a way that the ducts have a common end portion 54. It is thus possible to feed to the reaction chamber 12 a mixture of solid particles separated from the pyrolysis gases and hot solid particles fed from the circulating fluidized bed boiler 44, the temperature of which is between the temperature of the solid particles separated by the particle separator 16 and the temperature of the solid particles of the circulating fluidized bed boiler 44.

FIG. 1 shows that the inlet duct 52 bringing hot solid particles to the pyrolyzer is connected to a side wall of the furnace of the circulating fluidized bed boiler 44. In practice, the inlet duct 52 can also be connected to a particle separator of the discharge gas duct of the circulating fluidized bed boiler 44, whereby circulating material for the boiler is brought to the pyrolyzer 10, or to the lower portion of the furnace of the circulating fluidized bed boiler 44, whereby so-called bottom ash is brought to the pyrolyzer 10. The hot material can move in the duct 52 by means of gravitation, as in FIG. 1, or it can be transferred in some other way, for example, by means of a conveyor screw or conveyor gas.

If the temperature of the solid particles returned from the separator 16 is 500° C. and the temperature of the particles introduced from the circulating fluidized bed boiler 44 is 850° C., the temperature of the particle mixture led via the duct portion 54 to the reaction chamber 12 can have a temperature varying between 500° C. and 850° C., for example 650° C. The particle mixture, which has a larger mass flow than the original, but a lower temperature than the original, brings effectively as much thermal energy to the reaction chamber as the mere particle flow directly from the circulating fluidized bed boiler 44 at the temperature of 805° C. Due to the lower temperature, it causes, however, considerably less undesired decomposition of fuel molecules taking place in the inlet area, and thus, the yield of the pyrolysis oil of the pyrolyzer 10 improves.

A lifting channel 58 fluidized by fluidizing means 56 advantageously forms a part for the inlet duct 52 connected to the circulating fluidized bed boiler 44. The lifting channel 58 acts as a gas seal between the circulating fluidized bed boiler 44 and the reaction chamber 12 of the pyrolyzer 10. By means of the flow of the fluidizing gas fed through the fluidizing means 56, it is possible to adjust the volume of the hot solid particle flow introduced from the circulating fluidized bed boiler 44 to the reaction chamber 12 and, thus, to control the temperature of the reaction chamber 12. Typically, the pyrolysis process has a rather accurately defined optimum temperature, and if the temperature is exceeded or if it is failed to reach, the yield of the desired substances diminishes. According to a preferred embodiment, the fluidizing means 56 of the lifting channel 58 of the inlet duct 52 are guided based on the temperature indicated by a temperature sensor 60, for example, a thermocouple, arranged to the upper portion of the reaction chamber 12, in such a way that the desired temperature of the reaction chamber 12 is achieved.

According to a preferred embodiment, the lifting channel 58 is arranged close to the circulating fluidized bed boiler 44, for example, in connection with the outer wall of the boiler, whereby an extension portion 48 of the return duct 30 can preferably be connected to a descending portion of the inlet duct 52, downstream of the fluidized lifting channel 58. According to an especially preferred embodiment, the extension portion 48 of the return duct 30 can preferably be connected to the inlet duct 52 in a manner disclosed in FIG. 1, in other words, at the fluidizing lifting channel 58, and most preferably, at the upper portion of the lifting channel 58. Thereby, the hot solid particles coming through the inlet duct 52 and the cooler particles coming through the return duct 30 mix efficiently in the lifting channel 58 because of the fluidization, and the particle flow fed to the reaction chamber is at a temperature, which corresponds to the weighted average of the temperatures of the mass flows. This results in that no poorly mixed subflows with momentarily different temperatures are allowed into the reaction chamber 12, which subflows could cause non-desired chemical reactions in the reaction chamber 12, and, for example, a poorer yield in pyrolysis oil.

Fluidizing means 34 of the lifting channel 36 can preferably be controlled based on the temperature indicated by a temperature sensor 62 arranged to the common end portion 54 of the return duct 30 and the inlet duct 52. Since the material arriving from the particle separator 16 is approximately at the same temperature as that of the reaction chamber 12, adding of its mass flow does not substantially affect the temperature of the reaction chamber 12. Adding of the mass flow of the material arriving from the particle separator 16 decreases, however, the temperature of the solid particle mixture fed to the reaction chamber 12, thus, diminishing the problems resulting form the high temperature of the heat carrying material. A second advantage achieved by the invention is that when the mass flow of the material bringing heat increases, its mixing with fuel becomes more efficient, and the fuel achieves the desired optimum temperature more quickly.

The present invention is described above with reference to an exemplary embodiment, but the invention also comprises many other embodiments and modifications. Especially, the fluidized bed reactor does not have to be a fluidized pyrolyzer, but it can also be of another type, and the second fluidized bed reactor does not have to be a circulating fluidized bed reactor, but it can also be the other type of fluidized bed reactor. The second fluidized bed reactor does not have to be at a temperature higher than that of the first fluidized bed reactor, but the temperature thereof may also be lower than that of the first fluidized bed reactor. The control means of the different solids flows do not have to be based on the fluidized lifting channels, but they can also be of other types of control means for mass flow, for example, conveyor screws. The apparatus separating solid particles does not have to be a cyclone, but it can also be some other device, such as a discharge channel connected to the lower portion of the reaction chamber. It is thus evident that the disclosed exemplary embodiment is not intended to restrict the scope of the invention, but the invention comprises a number of other embodiments which are limited by the accompanying claims and the definitions therein alone.

1. An apparatus for controlling the temperature of a fluidized bed reactor, the apparatus comprising:
a separator for separating first solid particles from the fluidized bed reactor;
a return duct for returning a first portion of the first solid particles to the fluidized bed reactor;
a discharge duct for removing a second portion of the first solid particles; and
an inlet duct for transferring second solid particles from a second fluidized bed reactor to the fluidized bed reactor,
wherein the return duct and the inlet duct share a common end portion for transferring a mixture of solid particles formed of the first portion of the first solid particles and the second solid particles to the fluidized bed reactor.

2. An apparatus according to claim 1, further comprising a mixing apparatus for mixing the first portion of the first solid particles together with the second solid particles.

3. An apparatus according to claim 2, wherein the mixing apparatus comprises means for fluidizing the first portion of the first solid particles and the second solid particles.

4. An apparatus according to claim 1, wherein the discharge duct is connected to conduct the second portion of the first solid particles to the second fluidized bed reactor.

5. An apparatus according to claim 1, wherein the return duct comprises a controller for controlling the mass flow of the first portion of the first solid particles.

6. An apparatus according to claim 1, wherein the discharge duct comprises a controller for controlling the mass flow of the second portion of the first solid particles.

7. An apparatus according to claim 1, wherein the inlet duct comprises third a controller for controlling the mass flow of the second solid particles.

8. An apparatus according to claim 5, wherein the controller comprises a fluidized lifting channel.

9. An apparatus according to claim 5, wherein the controller comprises a fluidized lifting channel, which is connected to a common down leg.

10-31. (canceled)

32. An apparatus according to claim 5, wherein the controller comprises a conveyor screw.

33. an apparatus according to claim 6, wherein the controller comprises a fluidized lifting channel.

34. An apparatus according to claim 6, wherein the controller comprises a fluidized lifting channel, which is connected to a common down leg.

35. An apparatus according to claim 6, wherein the controller comprises a conveyor screw.

36. An apparatus according to claim 7, wherein the controller comprises a fluidized lifting channel.

37. An apparatus according to claim 7, wherein the controller comprises a fluidized lifting channel, which is connected to a common down leg.

38. An apparatus according to claim 7, wherein the controller comprises a conveyor screw.

39. An apparatus according to claim 5, wherein a common end portion of the return duct and the inlet duct comprises a temperature sensor for measuring the temperature of the mixture of solid particles.

40. An apparatus according to claim 6, wherein a common end portion of the return duct and the inlet duct comprises a temperature sensor for measuring the temperature of the mixture of solid particles.

41. An apparatus according to claim 39, further comprising means for guiding the controller based on the temperature of the mixture of solid particles.

42. An apparatus according to claim 40, further comprising means for guiding the controller based on the temperature of the mixture of solid particles.

43. An apparatus according to claim 7, further comprising means for guiding the controller based on the temperature of the mixture of solid particles.

44. An apparatus according to claim 5, further comprising means for guiding the controller based on the temperature of the upper part of the fluidized bed reactor.

45. An apparatus according to claim 6, further comprising means for guiding the controller based on the temperature of the upper part of the fluidized bed reactor.

46. An apparatus according to claim 7, further comprising means for guiding the controller based on the temperature of the upper part of the fluidized bed reactor.

47. An apparatus according to claim 1, wherein the separator comprises a cyclone arranged in a flue gas channel of the fluidized bed reactor.

48. An apparatus according to claim 1, wherein the fluidized bed reactor is a pyrolyzer.

49. An apparatus according to claim 1, wherein the second fluidized bed reactor is a circulating fluidized bed boiler.

50. An apparatus according to claim 1, wherein the second fluidized bed reactor is a bubbling bed boiler.

51. A method of controlling the temperature of a fluidized bed reactor, the method comprising:
separating first solid particles from the fluidized bed reactor;
transferring a first portion of the first solid particles along a return duct back to the fluidized bed reactor;
removing a second portion of the first solid particles; and
transferring second solid particles along an inlet duct from a second fluidized bed reactor to the fluidized bed reactor,
wherein the first portion of the first solid particles and the second solid particles are mixed with each other and the mixed solid particles thus formed are transferred along a common end portion of the return duct and the inlet duct to the fluidized bed reactor.

52. A method according to claim 51, further comprising mixing the first portion of the first solid particles and the second solid particles together in a fluidized mixing chamber.

53. A method according to claim 51, further comprising removing the second portion of the first solid particles along a discharge duct to the second fluidized bed reactor.

54. A method according to claim 51, further comprising controlling the mass flow of the first portion of the first solid particles using a controller arranged in the return duct.

55. A method according to claim 51, further comprising controlling the mass flow of the second portion of the first solid particles using a controller arranged in the discharge duct.

56. A method according to claim 51, further comprising controlling the mass flow of the second solid particles using a controller arranged in the inlet duct.

57. A method according to claim 51, further comprising measuring a temperature of the mixture of solid particles by a temperature sensor arranged in the common end portion of the return duct.

58. A method according to claim 57, further comprising controlling one of the inlet duct and the controller based on the temperature of the mixed solids.

59. A method according to claim 52, further comprising measuring a temperature of the mixture of solid particles by a temperature sensor arranged in the common end portion of the return duct.

60. A method according to claim 59, further comprising controlling one of the inlet duct and the controller based on the temperature of the mixed solids.

61. A method according to claim 51, further comprising measuring the temperature of an upper part of the fluidized bed reactor and controlling the controller based on the temperature of the upper part of the fluidized bed reactor.

62. A method according to claim 51, wherein the first solid particles are separated by means of a cyclone arranged in the flue gas channel of the fluidized bed reactor.

63. A method according to claim 51, wherein the fluidized bed reactor is a pyrolyzer.

64. A method according to claim 51, wherein the second fluidized bed reactor is a circulating fluidized bed boiler.

65. A method according to claim 51, wherein the second fluidized bed reactor is a bubbling bed boiler.
